(19) United States
(12) Patent Application Publication
(10) Pub. No.: US 2024/0042503 A1
(43) Pub. Date: Feb. 8, 2024

(54) SYSTEMS AND PROCESS FOR SOLAR PANEL RECYCLING

(71) Applicant: CHZ TECHNOLOGIES, LLC, Austintown, OH (US)

(72) Inventors: Henry W. Brandhorst, Jr., Auburn, AL (US); Ullrich H. Engel, Camberg (DE); Charles T. Ludwig, Auburn, AL (US); Ernest J. Zavoral, Sr., Canfield, OH (US)

(21) Appl. No.: 18/258,242

(22) PCT Filed: Jan. 4, 2022
(86) PCT No.: PCT/US22/11082

§ 371 Date: Jun. 19, 2023

Related U.S. Application Data
(60) Provisional application No. 63/199,509, filed on Jan. 4, 2021.

(51) Int. Cl. B09B 3/70; B09B 3/40

(52) U.S. Cl. CPC B09B 3/70; B09B 3/40; B09B 2101/15

(57) ABSTRACT

Clean, safe and efficient methods and systems for utilizing thermolysis methods to recycle end of life solar cells and panels to remove fluorine and other hazardous materials while collecting valuable recoverables are provided. The methods and systems beneficially convert the solar cells and panels into a Clean Fuel Gas and Char source. The methods and systems further provide the ability to recover valuable components from the Char, wherein the highly valuable recoverables can be used for further applications and uses.

### CROSS-REFERENCE TO RELATED APPLICATIONS

This application claims priority under 35 U.S.C. § 119 to provisional application U.S. Ser. No. 63/199,509 filed Jan. 4, 2021, herein incorporated by reference in its entirety. The entire contents of this patent application are hereby expressly incorporated herein by reference including, without limitation, the specification, claims, and abstract, as well as any figures, tables, or drawings thereof.

### FIELD OF THE INVENTION

The invention relates to clean, safe and efficient methods and systems for utilizing thermolysis methods to recycle end of life solar cells and panels in order to remove halogens, including fluorine (and stable poly fluoroaliphatic compounds) and chlorine compounds, and other hazardous materials while collecting valuable recoverables. The methods and systems beneficially convert the solar cells and panels into a Clean Fuel Gas and Char source. The methods and systems further provide the ability to recover valuable components from the Char, wherein the highly valuable recoverables can be used for further applications and uses, and can include copper from wiring, single- and polycrystalline silicon and other polymers from bonding sheets within the panels. The thermolysis methods and system provide an advanced pyrolysis methodology for heating and converting these waste sources as disclosed herein.

### BACKGROUND OF THE INVENTION

Solar panels, also referred to as photovoltaic (PV) devices generate electricity from sunlight through an electronic process in semiconductors. Electrons in semiconductors are freed by solar energy and travel through electrical circuits to power devices and/or send electricity to a grid. See SEIA—Solar Energy Industries Association (https://www.seia.org/initiatives/photovoltaics). As the global use of these solar technologies has increased there is burgeoning a demand for recycling of end of life solar panels and cells. There is significant interest and incentives to processing and ideally recycling these solar panels and cells in a clean, safe and efficient manner. In addition, various regulations in the U.S. and/or globally may aim to restrict or limit landfill dumping of these types of end of life products, resulting in further need to identify alternative methods and processing for their recycling.

The general structure of a silicon cell-based solar panel is depicted in FIG. 1. As referred to herein solar panels are made up of multiple connected solar cells (e.g. 60 or more). The metal (i.e. aluminum) frame and glass paneling provide a desirable source of recyclable materials. The remainder of the panels are in need of being processed, including films, solar cells themselves, cabling, backings, etc. These various films and the solar cells themselves provide sources of valuable materials that could be utilized in various applications if safe and effective processing were developed. A further exemplary structure of a portion of a thin film solar panel is depicted in FIG. 2, wherein a Kynar fluorinated backsheet (PVDP-PET-PVDF) structure is employed. In still further embodiments, PVF backsheets are often further employed. In still further embodiments, the PVF or PVDF polymer sheets may also contain a recoverable white mineral additive to increase reflectivity of the panel. There are many solar cell systems including those based on cadmium telluride (CdTe), copper indium gallium selenide (CIGS), amorphous silicon (α-Si), gallium arsenide (GaAs), and perovskite-based for example.

A unique concern when recycling the solar panels and cells is the processing of the Tedlar or Kynar films, coatings and/or backings on these materials. These components contain high levels of fluorine and chlorine (PVC). For example, Tedlar is reported to contain approximately 1.9 grams/ft² of fluorine (˜15 grams/panel based on an average panel size). This presents a significant challenge as these fluorine sources are very stable poly fluoroaliphatic compounds and are therefore difficult to decompose. These fluorine and chlorine-containing materials are in need of clean, safe and efficient methods for recycling.

Poly fluoroaliphatic compounds are a group of synthetic chemicals that are classified as perfluoroalkyl substances or polyfluoroalkyl substances (PFAS). As referred to herein PFAS can also be referred to as PFOS (which are specifically the water soluble and most difficult to destroy or remove) of the family of perfluoro compounds. PFAS chemicals are known as “forever chemicals” because of their long half-life and remarkable stability. PFAS represents a family of synthetic perfluoro compounds possessing incredible persistence in both the environment and the human body. The carbon-fluorine bond is one of the strongest bonds in organic chemistry (due to the low molecular weight of the fluorine, where the molecular weight is inversely related to the C-halogen bond strength). For example, the C—F bond strength is 115.8 kcal/mole whereas the C—Br bond strength is only 65.9 kcal/mole. As a result, the C—F bond is chemically resistant to a broad range of organic and inorganic solvents, acids, bases, enzymes, biologicals, UV radiation and other approaches used in traditional chemical decomposition.

Accordingly, it is an objective of the methods and systems described herein to solve the problem and need in the art for clean, safe and efficient methods for processing end of life solar panels and cells and safely eliminate chlorine and fluorine-containing polymers.

A further object of the disclosure is to provide methods and systems for utilizing thermolysis methods to safely and efficiently convert various solar panel and cell waste sources to a Clean Fuel Gas and Char source without generation (and further the removal of) toxic byproducts. As a result, the methods and systems would meet even the most rigid environmental standards that may be set forth for recycling and/or processing of such waste sources.

A further object of the disclosure is to provide methods and systems for utilizing thermolysis methods to safely and efficiently convert various solar panel and cell waste sources to a Clean Fuel Gas and Char source, wherein the Char contains valuable photovoltaic materials (e.g., Si, GaAs C, copper and other metals and any glass) unless such materials were removed before processing. In particular, the generation of a Clean Fuel Gas provides a desirable waste-to-energy pathway from a previously unutilized waste source (i.e. solar panels and cells) through the recycling of tars and oils to generate Clean Fuel Gas to thereby reuse the energy that went into the original fabrication of the solar panels and cells. In a further application, the generation of the Char source is suitable for further recycling and/or use of the Char source for further separation of desirable components (e.g. silicon, metals, photovoltaic materials, glass) for various applications as disclosed pursuant to the invention.

A further object of the invention is to utilize thermolysis methods to remove all halogen compounds, including fluorine and chlorine compounds, while beneficially not generating any additional toxic compounds.

A further object of the invention is to utilize thermolysis methods to generate clean, useable fuel gas sources substantially-free or free of halogens (including fluorine and chlorine) and other halogenated organic compounds (including VOCs).

A further object of the invention is to utilize thermolysis methods to generate Char containing valuable materials that can be recovered, including for example photovoltaic materials, such as silicon and metals that can be reused as well as components from glass panels and aluminum frames that can be recycled for further solar panel construction.

Other objects, advantages and features of the present invention will become apparent from the following specification taken in conjunction with the accompanying drawings.

### BRIEF SUMMARY OF THE INVENTION

An advantage of the invention is the clean and efficient methods and systems for utilizing Thermolysis methods to safely and efficiently convert solar panel and solar cell waste sources to recyclable components, Clean Fuel Gas and Char source. It is a further advantage of the present invention that the waste sources are converted by destroying halogenated compounds and halogens including fluorine, bromine and chlorine present therein; clean, reusable fuel gas sources substantially-free or free of halogens and other VOCs are generated; and a Char source containing valuable materials are further generated.

In a further aspect, products produced by the described methods for converting solar panel and cell waste sources are provided.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows the general structure of solar panels to be processed and recycled by the methods and systems described herein, wherein an exemplary and the depicted structure includes metal frame 12, glass panel 14, EVA film 16, solar cells 18, PVF/PVDF films, and junction box 22.

FIG. 2 shows an exemplary structure of a solar panel using Kynar backsheets to be processed and recycled by the methods and systems described herein, wherein an exemplary and the depicted structure includes an inner side 30, air side 32, PDVF 34, adhesive 36, and PET 38.

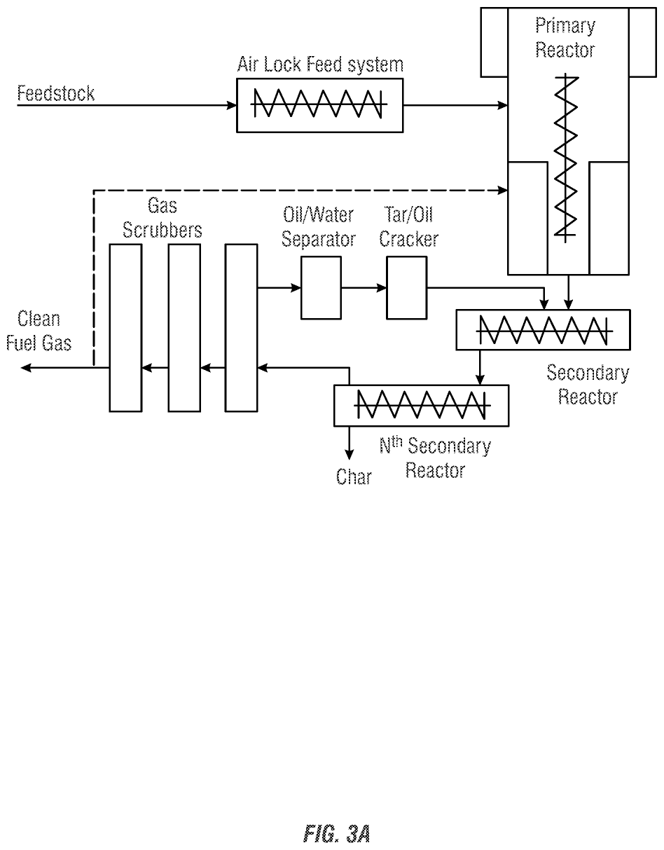

FIGS. 3A-3B show exemplary process diagrams for the methods and systems of the present invention.

Various embodiments of the present invention are described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE PREFERRED EMBODIMENT

The embodiments of this invention are not limited to particular methods and systems, and/or the resultant products for thermolysis methods to safely and efficiently convert various solar panel and cell waste sources, which can vary and are understood by skilled artisans. It is further to be understood that all terminology used herein is for the purpose of describing particular embodiments only and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form. Numeric ranges recited within the specification are inclusive of the numbers defining the range and include each integer within the defined range.

Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

The term “about,” as used herein, refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

As used herein, the term “exemplary” refers to an example, an instance, or an illustration, and does not indicate a most preferred embodiment unless otherwise stated.

The term “substantially-free,” as used herein may refer to a minimal amount of a non-desirable and/or toxic component in a material, such as a clean fuel gas and Char generated by the methods, processes and systems of the invention. In an aspect, a material is substantially-free of a defined component if it contains less than a detectable amount of the defined component, or less than about 10 parts per billion (ppb), or more preferably less than about 1 ppb. In an embodiment, Char and fuel gas generated according to the processing of waste is substantially-free of toxins, including halogens, having less than about the detection limit of about 10 ppb, or more preferably less than about 1 ppb of the toxin, including halogens. For toxic and/or hazardous materials, free represents an amount below the detection limit of the appropriate material within experimental error. In an aspect of the invention the Char source and fuel gas source generated according to the processing of solar panel and cell waste sources are free of toxins, indicating that there is a non-detectable amount of toxins in the measured source.

The term “substantially-free,” as used herein referring to oxygen in the thermolysis methods refers to a minimal amount of oxygen or air. In an aspect, a system is substantially-free of oxygen if it contains less than about 4 wt.-%, and preferably less than about 2 wt.-%.

The term “thermolysis” as used herein is generally referred to as a thermal-chemical decomposition conversion process employing heat to an input source in need of conversion to a Clean Fuel Gas and Char source. Thermolysis refers generally to thermal-chemical decomposition of organic materials at temperatures >300° C. and in some instances in the absence of external oxygen to form gases, tars, and oils and Chars that can be used as chemical feedstocks or fuels. Tars and oils represent groups of volatile organic compounds, viscous liquids, paraffins, waxes, aromatics, aliphatics, fats and other petrochemical based organic mixtures for example. The thermolysis methods disclosed according to the present invention are an advancement over conventional pyrolysis and/or thermolysis methods, which employ fire or a heat source and include an oil as an output. As described herein according to the invention no oil is generated as an output of the thermolysis methods of the present invention. As disclosed in further detail herein, the present thermolysis methods employ at least a reprocessing of any tars and oils. Based on at least these distinctions between the thermal conversion methods, the terms thermolysis and pyrolysis are not synonymous, as thermolysis provides various beneficial improvements not previously achieved by pyrolysis methods and/or conventional thermolysis methods.

The term “weight percent,” “wt.-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt.-%,” etc.

The methods and systems may comprise, consist essentially of, or consist of the components and ingredients of the present invention as well as other ingredients described herein. As used herein, “consisting essentially of” means that the methods and systems may include additional steps, components or ingredients, but only if the additional steps, components or ingredients do not materially alter the basic and novel characteristics of the claimed methods, processes and/or systems.

It should also be noted that, as used in this specification and the appended claims, the term “configured” describes a system, apparatus, or other structure that is constructed or configured to perform a particular task or adopt a particular configuration. The term “configured” can be used interchangeably with other similar phrases such as arranged and configured, constructed and arranged, adapted and configured, adapted, constructed, manufactured and arranged, and the like.

The methods and systems of the present invention relate to thermolysis methods to safely and efficiently convert various solar panel and cell waste sources to a Clean Fuel Gas and Char source. Beneficially, the methods and systems provide significant and unexpected advances beyond conventional thermolysis methods. For example, conventional combustion processes which burn waste sources are highly unpredictable and difficult to control. Although advancements in thermolysis have been made in the prior art, the present invention beneficially exceeds the capabilities of known thermolysis methods in converting solar panel and cell waste sources into valuable outputs which beneficially destroy (and do not generate any new) toxic halogens and halogenated organic compounds present in the waste sources, in particular fluorine.

Moreover, the thermolysis methods of the invention include the use of multiple reactors, reinjection and cracking of any and all tars and oils that are created. As a further benefit, the methods and systems generate clean, useable fuel gas sources substantially-free or free of halogenated organic compounds, including all poly fluoroaliphatic compounds by the methods and systems. As a still further benefit, Char is generated containing valuable electronic metals, precious metals, and other materials such as silicon, all of which are substantially-free or free of halogenated organic compounds. Notably, the methods and systems of the present invention do not simply reduce the amounts of fluorinated and chlorinated compounds and other toxins, instead these are removed as salts (with no additional generation) from the treated solar panel and cell waste sources while further providing the useful and valuable outputs of the invention defined further herein.

Solar Panels and Cells—Waste Sources

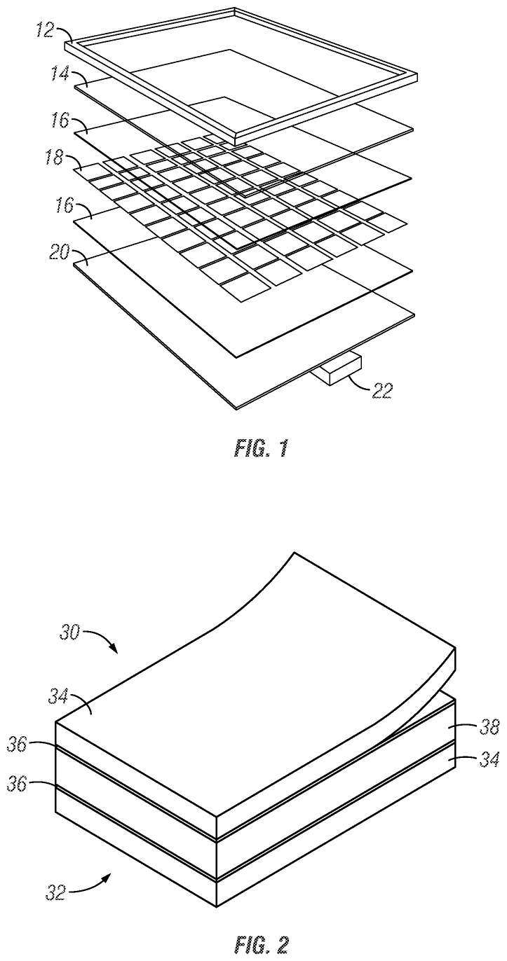

The methods and systems described herein relate to novel processes using thermolysis methods too safely and efficiently convert solar panels and cells into Clean Fuel sources and Char sources. The methods and systems described herein are suitable for safely and efficiently processing all types of solar panels and/or cells that include at least one layer of polymeric material in their construction (e.g. PVF, PVDF or EVA). As referred to herein, the processing of solar panels includes solar cells (i.e. individual device that converts light into electricity). Solar cells are encapsulated for weather protection into solar panels. In addition it is envisioned that any number of distinct solar cells can be processed as well. Therefore, the term “solar panels and/or cells” is used to refer to processing of any combination thereof. The solar panels are made up of various layers in structure, such as depicted in FIG. 1. The exemplary solar panel depicted in FIG. 1 includes metal frame 12, glass panel 14, EVA film 16, solar cells 18 (i.e. multiple cells in a single solar panel), PVF/PVDF films, and junction box 22. More generally, the components often include metal (i.e. aluminum) framing and mounting, glass paneling, multiple film layers between the solar cells themselves, and screws and/or other components for panels and cells. The components generally also include a junction box with wiring, cabling, backings, etc. These various films include polymeric coatings, including for example, ethyl vinyl acetate (EVA), polyethylene terephthalate (PET), polyvinyl chlorine (PVC), polyvinyl fluoride (PVF) and polyvinylidene fluorine (PVF/PVDF). In an embodiment, the waste products include at least one of the fluorinated compounds shown in Table A and optionally additional polymers described herein:

TABLE A

| | | MOLECULAR |
|---|---|---|
| NAME | CASRN | FORMULA |
| Poly(1,1-difluoroethylene) (PVDF) | 24937-79-9 | —(C₂H₂F₂)n— |
| poly(1-fluoroethylene) or poly vinyl | 24981-14-4 | (C₂H₃F)n |
| fluoride (PVF) | | |

In some embodiments, the glass panels often include non-glare low-iron glass that is about 1-10, or about 2-5 mm. Exemplary glass panels are low-iron glass bonded to a PV assembly with another EVA bonding film. Beneficially the polymers (e.g. EVA) are fully depolymerized by the methods described herein.

Other materials found in these components can include crystalline silicon (and/or polycrystalline n or p type poly-Si or mono-Si), various polymers in bonding sheets, tabbing wire, metal solder, such as silver-based solder as may be used to bond the silver wire to the silicon cells, bus wire as may be used to connect the multiple tabbing wires in each cell row, other connecting wire to connect the bus wire to a connector or PVC junction box containing diodes with additional wires connecting to a storage battery. In most embodiments, there are sheets of silicon sealed together with thin polymer films (e.g. EVA films) which are be designed to bond, coat, encapsulate and protect the silicon/wired assemblies. Further in various embodiments, the PV panels are sealed with silicon gasket rubber to secure and protect the assembled panel and help secure it within the metal frames.

As one skilled in the art will ascertain, the described waste sources can differ based upon factors including the metal types, glass types, polymer types, thickness and/or number of panels, density of solar cells, types and thickness of films, etc. that are employed in solar panels. In particular, there may be differences in the types of polymers and films employed, which may include but are not limited to EVA, PET, and PVF/PVDF. The methods and systems of the present invention unexpectedly recycle and convert these waste sources into desirable outputs.

Solar cells and filming between the panels and cells are generally formulated with highly fluorinated polymers, often referred to as thermoplastic fluoropolymers. For example, PVF, commercially available as Tedlar® (made by DuPont™) is a PVF film-based backsheet (i.e. film layer), and PVDF, commercially available as Kynar (made by Arkema) is a PVDF film-based backsheet, both of which are commonly used in as the outermost layer of a solar panel. In various embodiments of solar panels, PVF and/or PVDF sheets are often layered around polyethylene terephthalate (PET). These backsheets or film layers have significant fluorine concentration locked in the polymer matrix, as the double layering of fluoropolymers with fluorine atoms in the carbon chain provide protective properties to the panels. The layering of fluoropolymers must be safely processed to remove the fluorine instead of generating VOCs. This film and polymer are designed to provide long term moisture barrier (e.g. 20+ years) and therefore are durable fluorine compounds. These fluorine compounds are in the form of stable poly fluoroaliphatic compounds having carbon-fluorine bonds that are known to be difficult to break. Without being limited to a particular mechanism of action, the methods and systems described herein are able to decompose the poly fluoroaliphatic compounds by breaking the carbon-fluorine bonds, such as may be confirmed by thermo gravimetric analysis. This is a unique challenge in processing this waste source as safe processing cannot result in the halogenated groups (such as fluorine) being released in the processing system.

Thermolysis Methods

The methods and systems of the present invention relate to multicomponent and multistep, energy-assisted, chemical reaction using thermolysis methods to safely and efficiently convert various solar panel and/or cell waste sources to gas/vapor mixtures and carbonaceous materials, namely a Clean Fuel Gas source and a Char that contains various metals and silicon. In an aspect, the gas/vapor including halogens (in particular fluorine) are cleaned and removed as disposable salts. The metals are recovered substantially in their original form and most have not been melted. As a result of the methods described herein, a clean Char source, Clean Fuel Gas and fluoride salts are the only products of the system. In a further aspect fluoride salts are a byproduct that can be reused or disposed from the methods described herein in addition to the Char and Clean Fuel Gas.

Beneficially, the methods provide for complete defluorination of the poly fluoroaliphatic compounds found in the waste products. According to the methods described herein, at least 99% or at least 99.9% of the poly fluoroaliphatic compounds in the waste source are destroyed. Moreover, the at least 99% or at least 99.9% of the destroyed poly fluoroaliphatic compounds do not include any poly fluoroaliphatic byproducts formed during the methods. These destroyed compounds include toxic residues from the destruction of the poly fluoroaliphatic compounds. This includes for example, any short-chain fluoro-aliphatic byproducts, also referred to as short-chain fluorinated molecules (e.g., CF₄), gas byproducts (e.g., HF), highly electronegative fluorine atoms and free radicals, and halogenated dioxins and furans. These byproducts are often more volatile that the poly fluoro-aliphatic compounds and present an extreme environmental hazard. Therefore, it is critical that the methods destroy these byproducts in addition to the poly fluoro-aliphatic compounds. Beneficially, the destruction or neutralization of these byproducts prevents the need for any further incineration and/or landfilling in a hazardous waste facility.

As referred to herein the thermolysis methods employ a continuous, oxygen-free thermal processing for the solar panel and/or cell waste sources using heat energy. Beneficially, the methods and systems of the present invention convert the solar panel and/or cell waste sources by destroying and not generating additional toxic halogenated organic compounds present in solar panel and/or cell waste sources. As a further benefit, the methods and systems of the present invention generate clean, useable fuel gas sources substantially-free or free of halogenated organic compounds. As a still further benefit, the methods and systems of the present invention generate a Char containing valuable metals, photovoltaic materials and silicon which are substantially-free or free of halogenated organic compounds and which can be extracted to obtain further value from the methods. In an aspect of the invention, at least 50% recovery of the metals and photovoltaic materials, which can include for example metals, precious metals (e.g. silver), and electronic metals (e.g. copper, aluminum) from the Char through separation methods, preferably at least about 55%, preferably at least about 60%, preferably at least about 65%, preferably at least about 70%, preferably at least about 75%, preferably at least about 80%, preferably at least about 85%, and most preferably at least about 90%, 95% or more.

In an embodiment, the methods of using a multicomponent and multistep, energy-assisted, chemical reaction to defluorinate the waste sources include the steps of inputting the material and/or waste sources into the thermolysis system, cleaving the C—C and the C—H bonds (resulting in an abundance of H₂ along with C₁-C₄ aliphatic chains) and cleaving the C—F bonds by providing an excess of H₂ in the reactor(s) to drive the formation of HF. The H—F bond is the strongest of the fluorine bonds. The fluorinated polymer fragments continue to process in the reactor until all fluorine is converted to HF.

In some embodiments the waste source is saturated with an excess of hydrogen (protons) to drive the reaction with fluorine atoms to form HF. Without being limited to a particular mechanism of action, with the abundant presence of H₂ from the polymer decomposition and the high electronegativity of the fluorine atom, there will be strong chemical force to form HF. In an embodiment, excess hydrogen can be provided to the reactor(s) to create a further abundance of hydrogen to drive the formation of the preferred stable form of HF. Thereafter the HF (which is in the form of a hot gas) is captured and converted to the gas scrubber(s) within the system. There the HF is neutralized with a mineral basic compound. The mineral basic compound can include an aqueous solution, such as calcium base. In embodiments a mineral basic compound can be a sodium or potassium fluoride which is soluble in water, with the addition of a further removal step. Accordingly, a water-soluble calcium compound is utilized to precipitate CaF₂ for removal. This final step removes the fluorine halogens in a basic aqueous scrubber. In an embodiment, the neutralized HF is converted to a non-toxic mineralized salt, namely a fluoride salt (e.g. CaF₂) and can be disposed or reused. Again, without being limited to a particular mechanism of action, the high hydration/solvation energy of the H-halogen species causes them to dissolve immediately and then they are safely removed by basic neutralization into non-toxic mineral salts (e.g. calcium or sodium fluoride). In an embodiment, the neutralized ionic mineral salts could be further repurposed as a building block (or raw material) for synthesis of other fluorinated compounds.

As a still further benefit, the invention providing for the generation of a Clean Fuel Gas and Char without the formation of (along with the destruction of) halogenated compounds beneficially prolongs the life span of the systems employed for the thermolysis methods. Without being limited according to a particular mechanism, the reduction of formation of halogenated compounds reduces the corrosive damage caused to the systems, such as valves, filters, reactors and the like. As an example, hydrogen bromide is known to form hydrobromic acid in solution with water.

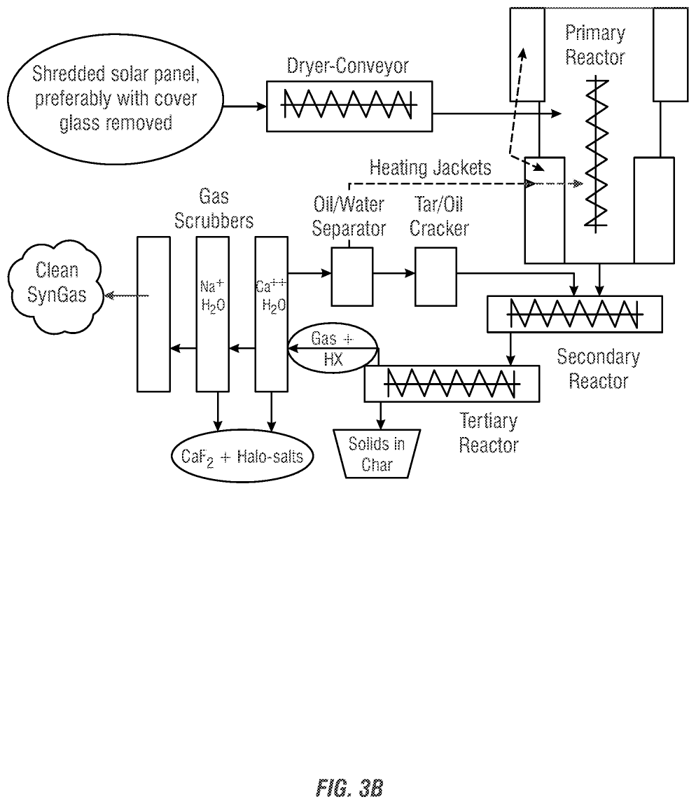

In an aspect the systems and apparatuses utilized for the methods and processes of the present invention includes at least the following components as substantially depicted in FIG. 3A, including: a feedstock input, airlock, at least one reactor (and preferably a series of reactors), gas scrubbers, tar/oil crackers (or may be referred to as cracking reactor), collection tanks for Char, and output for Clean Fuel Gas. Additional optional components may include for example, a carbon removal unit for removal of carbon from the Char (or other removal units to remove additional valuable components from the Char). Modifications to these systems and apparatuses, including as described herein, are considered within the level of ordinary skill in the art based upon the description of the invention set forth herein.

In an aspect the systems and apparatuses utilized for the methods and processes of the present invention includes at least the following components as substantially depicted in FIG. 3B, including: a feedstock input, at least one reactor (and preferably a series of reactors), collection tanks for Char, gas scrubbers, collection tanks for fluoride salts, oil/water separators, tar/oil crackers (or may be referred to as cracking reactor), and output for Clean Fuel Gas.

In an aspect the methods and systems include the following processing steps: shredding, chopping and/or grinding of the waste input; a reaction or series of thermolysis reactions in a substantially oxygen-free continuous, low pressure thermolysis process with indirect heating; employing more than one reactor for the thermolysis reactions; separation of Char; a tar and oil reprocessing or cracking step; and scrubbing of the fuel gas.

The methods and systems of the present invention may optionally include one or more of the following steps: an initial separation of components of the solar panel and/or cell waste sources, such as removing metal framing and/or glass panels for reuse/recycle); drying the waste input; removing any other valuable components from the waste source (e.g. the solar cells or portions thereof); extraction of metals or other components from the ground and/or shredded waste input; separation steps and/or additional gas scrubbers; and/or collection and separation of components from the Char (e.g. metals, silicon).

The methods and systems of the present invention can be carried out in a variety of apparatus for thermolysis. An exemplary device or series of reactors, further including oil and other separators, char/oil separators, gas scrubbers, evaporators, and the like are shown for example in U.S. Pat. No. 9,631,153, which is incorporated herein by reference in its entirety. As a benefit, the systems can be scaled for small, transportable systems for deployment to clean and process waste sources at remote contaminated sites and/or provide law scale facility thermolysis systems to process 10, 50, or near 100 tons of waste sources per day. As a further benefit, the methods utilizing these systems provide a far more cost-effective (in addition to safe) processing of the waste sources, including less than one tenth the cost of high temperature incineration.

In an aspect the invention includes an initial optional step of separating solar panel waste sources for processing according to the invention. In an aspect, one or more portions of the waste may be separated for independent processing, recycling and/or reuse. For example, metal frames and/or glass from the solar panel waste sources can be separated from the remainder before processing. In an embodiment, metal (e.g. aluminum) extruded frame that are used for the solar panel support and the mounting attachment are removed and separated from the panel. The removal and separate can be conducted in various manners, such as removing screws to detach the metal frame from the panel.

In an aspect, the invention includes an initial shredding, chopping and/or grinding step of the waste source, each of which may be referred to herein as shredding. The scope of the invention is not limited with respect to this initial processing step to reduce the size of the waste and provide a substantially uniform input source. In an aspect, the waste source can be placed directly into a grinder or shredder. In an aspect, the grinding and/or shredding step provides substantially uniform pieces of the input source. In an aspect, the grinding and/or shredding step provides pieces of the input source having an average diameter of less than about 2 inches. In an aspect, the shredding and/or grinding can include a first course step followed by a fine shredding and/or grinding step. In an alternative aspect, the shredding and/or grinding can include a single processing step. Various conventional shredding and/or grinding techniques may be employed without limiting the scope of the invention described herein.

Beneficially, according to the invention a variety of solar panel and/or cell waste sources can be processed according to the invention without substantial extraction steps to remove or separate various components for distinct and separate processing. This is a significant benefit over processing systems and techniques of the prior art requiring substantial sorting and separation of components of waste sources.

In an aspect, the invention includes an optional extraction step for the removal of certain metals (or other components) from the ground and/or shredded waste source input. In an aspect, a step for extraction of metals (or other components) immediately follows the shredding and/or grinding of the waste source. The removal step may include any techniques known to those skilled in the art to which the invention pertains, including a combination of mechanical and/or manual removal. In an aspect, the separation may include the use of magnet separators, including magnetic and high magnetism separators, for the attraction and removal of ferrous metals. In a further aspect, the use of eddy current can be used to remove metals, such as copper and aluminum. In an aspect, the separation may include the use of electrostatic separation. In an aspect, the separation may include the use of specific gravity separation. In an aspect, the separation may include the use of an air or fluid sorting device.

In an aspect, the methods and systems involve a reactor or series of thermolysis reactors using a substantially oxygen-free (or oxygen-free) continuous, low pressure, thermolysis process using heat energy. In an aspect, low pressure includes from about 10 to about 100 millibar, or any range therein. In an aspect, the invention involves an oxygen-free continuous, low pressure, thermolysis process in a reactor or series of reactors. As referred to herein, the oxygen-free process in the reactor(s) does not include air or oxygen in contact with the waste input source. Beneficially, as a result of the reduction and/or elimination of oxygen from the methods and systems of the present invention, the waste input sources are not exposed to flame and/or fires or plasma source and therefore do not form polycyclic aromatic hydrocarbons (PAHs), halogenated dibenzodioxins, halogenated dibenzofurans, biphenyls, and/or pyrenes, or other halogenated (e.g. fluorinated) organics.

In an aspect, the total aggregate composition of the solar panel and/or cell waste sources comprising up to 10% halogen content are processed according to the methods and systems of the present invention without the creation of PAHs, halogenated dibenzodioxins, halogenated dibenzofurans, biphenyls, and/or pyrenes. In an exemplary embodiment, measured Tedlar in a solar panel makes up approximately 1% of the total mass and Tedlar has 41% fluorine, which is less than 0.5% halogen content in the solar panel. In another exemplary embodiment, for silicon solar panels without glass covers fluorine content is approximately 5.3%. In various embodiments where the waste source can vary, such as introduction of wiring with polyvinyl chloride or other halogens, it is still desirable for processing of the waste sources to have up to 10% halogen content.

In a further aspect, the invention further includes the destruction of toxins, namely halogen compounds in addition to not generating any toxins as mentioned above. In an aspect, the methods destroy aliphatics, aromatics, and polycyclic aromatic hydrocarbons, halogenated dibenzodioxins, halogenated dibenzofurans, biphenyls, pyrenes, chlorofluorocarbons, etc.

In some aspects, silicon solar cell material can be recovered essentially in its original state. In some aspects, metals present in the waste source are recovered essentially in their original state.

In an aspect, the invention employs the substantially oxygen-free or oxygen-free continuous, low pressure thermolysis process with supply of heat energy. Thermolysis methods are known to employ different methods and amounts of heat energy, including for example: Low temperature thermolysis with a process temperature below 500° C.; medium temperature thermolysis in the temperature range 500 to 800° C.; and melting thermolysis at temperatures of 800 to 1,500° C. According to aspects of the present invention, the substantially oxygen-free or oxygen-free continuous, low pressure thermolysis process applies indirect heating. In an aspect, the heating includes processing the waste source input at temperatures of about 400° C.-800° C., preferably about 450° C.-600° C. The disclosed temperature ranges beneficially gasify the polymer film layers (e.g. layers of EVA bonding film), the junction box components (e.g. ABS junction box), and wiring (e.g. PVC wiring). Beneficially, such gasification provides the thermal energy required to process the panels. Without being limited to a particular mechanism of action, it is particularly unique that the fluorine in the films (namely the Tedlar or Kynar moisture backing sheets) are thermally cleaved from the thin polymer backing film and then captured in the scrubbers of the system where they are safely converted to fluoride salts for disposal.

Because the amount of hydrogen available from the EVA (or equivalent) bonding layers and the Tedlar (or equivalent) back layer, additional olefinic compounds such as polyethylene, PET, or similar, may be added to increase the total hydrogen content in the Fuel Gas. In an exemplary embodiment, a source of hydrogen, such as polymeric olefins (or olefin polymers), including for example HDPE, LDPE, polyethylene, polypropylene or combinations thereof, is added to the reactor system. In an embodiment, a ratio of PFAS material (e.g. fluorinated polymer) to excess hydrogen source (e.g. olefin polymers) can be from about 1 to about 2, about 1 to about 3, about 1 to about 4, about 1 to about 5, or greater.

Beneficially, the use of a lower temperature thermolysis process places less stress on a reactor(s) (such as steel reactors), requires less energy to run the continuous process according to the invention, and further maintains metals in contact with the system at lower temperature ranges which improves longevity, processing, etc. within a plant facility.

In an aspect, a reactor or series of reactors (also referred to as cascading reactors) allows for the thermolysis processing over the lower range of temperatures from about 400° C. to about 800° C., preferably about 450° C.-650° C. for thermal ranges. As one skilled in the art understands, there is not a single processing temperature for an input source according to the invention; instead, a range of temperatures within a reactor (or series of reactors) is obtained. In preferred aspects, the reactor(s) employed according to the methods of the invention do not require design for withstanding high temperature/pressure, as the relatively low temperature and pressures are employed (such as on average about 650° C. and ambient pressures of on average about 50 mbar).

The continuous thermolysis process is carried out in at least one reactor to undergo at least partial gasification. Various reactors known in the art can be employed, including for example, rotary drum reactors, shaft reactors, horizontal reactors, entrained-flow gasifiers, fixed-bed gasifiers, entrained-flow gasifiers, or the like. Exemplary reactors are disclosed, for example in, U.S. Pat. No. 9,631,153 and DE 100 47 787, DE 100 33 453, DE 100 65 921, DE 200 01 920 and DE 100 18 201, which are herein incorporated by reference in its entirety. As one skilled in the art will ascertain the number, sequence and scale of the reactors employed according to the invention can be adapted pursuant to the scale and volume of solar panel and/or cell waste sources inputted, which are embodied within the scope of the invention.

In some embodiments, a primary reactor employed according to the invention may comprise, consist of or consist essentially of input region with distributor, reactor mixing chamber, high-temperature region, high-temperature chamber, heating jacket chamber with burners, conversion section, inner register, and/or heat transfer register. In exemplary embodiments, a secondary (or tertiary) reactor employed and may comprise, consist of or consist essentially of gas compartment with dome, high-temperature chamber with vertical conveying device, inner register and outer register, conversion section with conveyor device, heating jacket chamber and/or combustion chamber.

In an aspect, the reactor(s) are jacket heated. In an aspect, the reactors are vertically and horizontally disposed. In an aspect, at least two reactors are employed. In an aspect, at least three reactors are employed. In an aspect, the reactor(s) may optionally undergo agitation. In a preferred aspect, at least one reactor or a primary reactor is vertical with a moving bed design and counter-current flow for the fuel gas along the heated walls into secondary reactors. Without being limited according to an embodiment of the invention, such designs minimize the creation of undesirable tars and fuel oils. In a further preferred embodiment, a moving bed design is further employed for a secondary horizontal reactor which extends the controlled reaction time and temperature of the fuel gas and char from improved solid/gas and gas/gas reactions according to the invention.

The solar panel and/or cell waste sources undergo the conversion in the reactor(s) for an amount of time sufficient to provide at least partial conversion and substantially as set forth according to the methods of U.S. Pat. No. 9,631,153. In an aspect, the amount of retention time in a reactor(s) varies from at least about 10 minutes, at least about 20 minutes, at least about 30 minutes, or more as may vary based upon factors including for example the shredded size of the input source which impacts the gasification reaction, and the like.

In an aspect, the pressure in the reactor(s) is held constant within a pressure range from about 10 to about 100 millibar, or preferably from about 20 to about 50 millibar.

In an aspect, the methods further include a tar and oil cracking step. As one skilled in the art appreciates, tars and oils are an unavoidable product of the pyrolysis process, which are a non-heterogenous mixture of olefins and paraffins, which contain tars and hazardous component. These hazardous components include carcinogenic benzene, toluene and halogenated components, depending upon the polymers in the waste source. The pyrolytic oils have a low flash point and are known to be extremely hazardous (often requiring hazardous regulatory permits in various countries).

Beneficially, according to the invention such unavoidably created tars and oils are merely an intermediate and are subsequently cracked. As referred to herein, “cracking” refers to the process whereby complex organic molecules are broken down into simpler molecules, such as light hydrocarbons, by the breaking of carbon-carbon bonds in the precursors. Thus, cracking describes any type of splitting of molecules under the influence of heat, catalysts and solvents. Accordingly, tars and oils are not collected or an output of the thermolysis methods of the invention. In an aspect, a further gas converter (cracking reactor) will be employed, such as where higher organic components are further degraded. This removal and conversion of these heavy oils or tars into Clean Fuel Gas is desired to remove these materials which selectively absorb halogenated hazardous substances. In an aspect, the step recycles tars and oils in order to remove the hazardous halogenated compounds. In a further aspect, the tar and oil cracking step has the beneficial effect of creating more clean fuel gas.

In an aspect, the generated tars and oils are processed in the presence of an optional catalyst, such as for example zeolite. In an embodiment, the cracking step separates light and heavy oils, such as disclosed for example in U.S. Pat. No. 9,631,153, which is incorporated herein by reference in its entirety.

In an aspect, the methods may further include an optional cooling step for the gas. In some embodiments, the gas will be cooled due to further processing in a scrubbing stage. For example, a cooled conversion chamber may be in connection with a reactor according to the methods of the invention. In an aspect, a gas at a temperature from about 400° C.-800° C. is cooled to a temperature below about 100° C., or preferably below about 80° C. The gas may further thereafter be cooled to an ambient temperature, such as in an adjacent water scrubber to remove any excess water and/or steam from the gas.

In an aspect, the methods may further include a conditioning step, such as employing and additional gas scrubbers. In an embodiment, gas produced may be further purified following cooling at a gas scrubbing stage, i.e. an alkaline stage (for example, NaOH for the binding of HCl and HBr), or Ca(OH)₂ for the binding of fluorine and fed to the downstream process. Thereafter the salts can be safely disposed.

In an aspect, the invention further includes a cleaning step for the further processing when mercury-containing compounds were included in the processed waste source. Elemental mercury will be removed in the water scrubber. Such step may also include the removal of mercury having formed a mercury halide, which may be as an insoluble halogen salt in water which is removed in the scrubber. In an aspect, the mercury halide is scrubbed out in the scrubber and thereafter disposed.

In an aspect, the invention further includes a cleaning step for the further processing of the generated fuel gas. Such step may be referred to as a “wet scrubbing” step. In an aspect, the gas is introduced as a gas flow into a wet scrubber for purification. In an aspect, the gas scrubber(s) separate tars, oils, and Char from the product gas flow. In a further aspect, the gas scrubber(s) can further cool the product gas, for example to a temperature below about 80° C. The scrubber(s) may further be employed for a final removal step for any toxic compounds in the fuel gas product.

In an aspect, the produced fuel gas/water vapor mixture enters the gas cleaning, i.e. scrubber system. In an aspect, each reactor line has its own first gas cleaning unit. The gas streams are combined after the first scrubber units and will enter the additional scrubbers afterwards.

In an aspect, the gas cleaning units include or consist of scrubbers, vessels, pumps, oil discharge units and heat exchangers. Water combined with additives, such as for example an alkalinity source (e.g. NaOH, or Ca(OH)₂) or other source such as limestone for removal of sulfur or fluorine, which are known to those skilled in the art of incineration technologies. Notably, the heating methods according to the invention are distinct from incineration as external heating is provided. For clarity, the methods of the invention do not employ incineration. Those skilled in the incineration arts understand scrubbing using water containing alkaline materials to remove acidic components are distinct methods. These are used in a closed loop system to clean condensates and contaminants out of the gas stream and to cool the gas down. The condensates contain olefins, aromatics and paraffins as solids and water. The standard system includes or consists of five gas cleaning systems. This amount can be reduced or increased depending on the feedstock specifications employed according to embodiments of the invention. The scrubbed components like tar will be the feedstock of the cracking reactors, the light oil fraction of aromatic oil and olefins will be separated from the solids/water and reprocessed in the gasification system and the water will be pre-cleaned and reused.

In an aspect, the invention will further include a recycling step for the recycling of any oils and tars created from the methods described herein. In an aspect, the recycling of the oils and tars involves cracking them and then reprocessing the shorter chain molecules into a main reactor to be converted into additional Clean Fuel Gas. In a beneficial aspect of the invention, such generated Clean Fuel Gas is suitable for use in maintaining operation of the processes of the invention at a point of use (i.e. facility employing the methods and systems of the present invention).

In an aspect, the invention further includes a separation step for the further processing of the generated Char source. In an aspect, the Char source generated according to the invention comprises metals in a fine metallic state. In a further aspect, the Char source generated according to the invention comprises metal(s) (e.g. from solder and/or internal attachment posts) and silicon (e.g. poly-Si). The Char can further include glass, copper wires, and other components. In some embodiments, the Char source can further undergo a subsequent separation step, such as to remove a desired component from the Char as may be accomplished by a variety of commercially known processes.

In one embodiment, a carbon conversion unit can be employed to remove carbon from a Char source. Beneficially, the generated Char source has undergone about a 40%, 50% or greater reduction (weight basis) as a result of the thermolysis processing according to the invention which removes the organics and thereafter can be further separated the remaining components. In an aspect it is desirable to remove additional carbon from the Char source, such that there is a great than 50% (weight basis) reduction of carbon in the Char source. In a preferred embodiment, the carbon is reduced to less than 10% (weight basis). In a preferred embodiment the carbon is removed from the Char source.

In an aspect, the further processing of the Char source can include the use of ozone to convert carbon to a fuel gas (in the form of carbon dioxide or carbon monoxide which thereafter are further processed through the scrubbers). In such an embodiment, ozone can be added to a chamber containing the Char (at either room or ambient temperature or at elevated temperatures, such as about 100° C. to about 300° C.). Such a chamber could be one of the reactors or a separate chamber. In an aspect, the use of ozone to convert carbon to a fuel gas obviates the use of a cold incineration process.

In an aspect, the further processing of the Char source incinerates the carbon in the residue at controlled temperatures, such as from about 300° C. to about 500° C. The air supply is temperature controlled and the whole process can be cooled, such as to a temperature from about 300° C. to about 500° C. Such process is referred to as a cold incineration process). In an aspect, the equipment includes or consists of an infeed screw conveyor, a rotary calciner with flights and register pipes for heat transfer, a cooled exit screw conveyor, exhaust gas cleaning unit with particulate removal and optional scrubbing devices.

In an aspect, the infeed screw conveyor has a conventional design, and the temperature of the co-product is the main parameter for its specification. The temperature of the co-product will be increased by indirect heating and controlled air supply before it enters the rotary calciner.

In an aspect, the rotary calciner has a basic design of an elongated drum with two bearings, an inner drum with flights and a central output screw conveyor. Input and output are symmetrical located. The drive is at the head of the rotary calciner. Input and output of the material is done via the shaft and thus gas proof to the atmosphere. A pipe register in two levels inside the drum will cool the process. The material can be transported by the inner flights into the output screw conveyor. The material can be continuously transported through the rotary calciner at a constant temperature and constant cooling. Moreover, carbon oxidizes to CO₂ in this process.

In an aspect, the output screw conveyor has a conventional design with a cooling jacket and connected to the storage vessel.

In an aspect, the exhaust gas cleaning module has a conventional particulate removal system and can be optionally equipped with a gas scrubber with solid removal. A fan can be added, if necessary, before entering the stack.

In an aspect of the invention, at least 50% recovery of the metals and/or silicon through separation methods, preferably at least about 55%, preferably at least about 60%, preferably at least about 65%, preferably at least about 70%, preferably at least about 75%, preferably at least about 80%, preferably at least about 85%, preferably at least about 90%, or most preferably at least about 95%. As referred to herein, “separation” means the division of the content or matter—in this case the metals and/or silicon in the Char—into constituent or distinct elements. Examples of separation techniques includes, for example, mechanical (i.e. shaking) separation, electrochemical processing, or the like. These and other benefits of processing the solar panel and/or cell waste sources according to the invention are disclosed here.

In an aspect, the fuel gas is transported through the gas cleaning system by increasing the pressure, such as to about 100 mbar by ventilation systems. In an aspect, 100 mbar is the limit value for the system employed according to the invention.

In an aspect, the wastewater treatment includes or consists of a physical and biological treatment segment. The wastewater can be discharged after pre-treatment and cleaning.

In an aspect, the safety system transports the fuel gas to a flare in case of an emergency. In an aspect, all the pipelines have valves, which automatically open in case of a power failure. In a further aspect, the connecting pipes to the flare are equipped with burst discs, which will prevent excessive pressure in the reactors and the gas cleaning systems. In case of an emergency, this system will help to shut down the system in a safe manner.

Generated Outputs of the Thermolysis Methods

In an aspect, the methods and systems of the present invention convert the solar panel and/or cell waste sources into fluoride salts, a Char source and a Clean Fuel Gas source. Beneficially, the hydrocarbon materials from the waste inputs are converted to the Clean Fuel Gas while the metals and carbon-coke will be collected as “Char.” As a further benefit, any oils and tars created are recycled into the secondary reactor and cracking reactor to be converted into additional fuel gas, such as may be employed to maintain operation of the processes of the invention at a point of use (i.e. facility employing the methods and systems of the present invention).

Fluoride Salts

The methods according to the invention employing the thermolysis methods beneficially provide fluorinated salts (e.g. CaF₂). In an aspect, the salts are substantially-free of (or free of) toxic chemicals and halogens and/or halogenated compounds.

Char

The methods according to the invention employing the thermolysis methods beneficially provide a processed Char comprising metal(s) and silicon from the solar cells and metallic interconnections. The Char can further comprise glass, carbon particulates/fine matter, and/or combinations of the same. In an aspect, the Char is a non-hazardous material. In an aspect, the Char is substantially-free or free of toxic chemicals. The Char must be cooled down before opening to air to prevent formation of hazardous dioxins and furans (such as for example to less than about 120° C.).

In an aspect, the Char is substantially-free of (or free of) toxic chemicals and halogens and/or halogenated compounds.

Fuel Source

The methods according to the invention employing the thermolysis methods beneficially provide a clean fuel source. In an aspect, the fuel gas source is a clean, non-hazardous material. In an aspect, the fuel gas source is substantially-free of toxic chemicals. In an aspect, the fuel gas source is substantially-free of halogens and/or halogen compounds and other toxic chemicals. In an aspect, the fuel gas source is free of toxic chemicals. In an aspect, the fuel gas source is free of halogens and/or halogen compounds. In a further aspect, the fuel gas source is free of toxic chemicals, halogens and halogen compounds. In an aspect, the fuel source is substantially-free or free of polycyclic aromatic hydrocarbons (PAHs), halogenated dibenzodioxins, halogenated dibenzofurans, biphenyls, and/or pyrenes.

In an embodiment, the fuel gas generated is utilized for heating the reactor(s) for the system and methods of the thermolysis methods of the invention. In an aspect, the heat for the reactor(s) is supplied by about 10-50% of the generated fuel gas, about 10-40% of the generated fuel gas, or about 20-30% of the generated fuel gas.

In an embodiment, the fuel gas generated has a composition as set forth in the Tables in the examples.

In an aspect, the fuel gas is a superior product as a result of no air or external oxygen introduced into the reactors, such as is common in pyrolysis and/or partial oxidation systems.

In an embodiment of the invention the thermolysis of solar panel and/or cell waste sources contain at least 100 BTU per pound, from about 1,000 to about 20,000 BTUs per pound of polymer waste, producing a Clean Fuel Gas as an energy source. As one skilled in the art will ascertain based on the disclosure of the invention set forth herein, differences in solar panel and/or cell waste sources will impact the BTUs per pound. For example, with a complete solar panel including cover glass, polymers, solar cells and other materials of construction, the polymer percentage may only be 2% thus reducing the average energy content to as low as 300 Btu/lb. Thus, the addition of additional polymeric wastes would be required to produce sufficient fuel gas to operate the thermolysis system and provide sufficient hydrogen for the safe removal of all halogens. This amount ranges from 50% of the mass of the solar panel to 200% of the mass of the solar panel (est.).

In an aspect, the generation of the fuel gas is suitable for various applications of use. In an embodiment, the generated fuel source can be used to generate electricity using engines or gas turbines to power a manufacturing plant and/or boilers as a replacement for natural gas and/or electricity. In another aspect, the fuel gas can be used for burners, or steam and electricity production and/or distribution. Many examples of such uses are well known to practitioners of the art.

The present disclosure is further defined by the following numbered paragraphs:

1. A method for recycling solar panels and/or cells into a Clean Fuel Gas and Char source comprising:
inputting a solar panel and/or cell waste source comprising at least one poly fluoro-aliphatic compound into a thermolysis system comprising at least one reactor, an oil/water separator, an oil/tar cracker, and at least one gas scrubbers; undergoing a depolymerization and a cracking reaction of hydrocarbons in the waste source;
thermally cleaving fluorine from the poly fluoro-aliphatic compounds in the waste source;
capturing the fluorine in the scrubbers of the system as HF gas and converting the fluorine to fluoride salts for removal or disposal;
destroying and/or removing toxic compounds present in the waste sources;
generating the Clean Fuel Gas and Char source that are substantially-free of halogenated organic compounds and do not include tars and/or oils; and
wherein the Char source contains recoverable metals, photovoltaic materials and/or silicon.

2. The method of paragraph 1, further comprising a first step of separating metal frames and/or glass from the solar panel and/or cell waste source.

3. The method of any one of paragraphs 1-2, further comprising an initial step of shredding the solar panel and/or cell waste source to provide a substantially uniform waste source.

4. The method of paragraph 3, wherein the solar panel and/or cell waste source has an average diameter of less than about 2 inches before it is inputted into the thermolysis system.

5. The method of any one of paragraphs 1-4, wherein the at least one reactor has a process temperature of from about 450° C.-800° C., preferably from about 450° C.-650° C. for the waste source to undergo at least partial gasification.

6. The method of any one of paragraphs 1-5, wherein the thermolysis system provides indirect heat in a system that is free of oxygen.

7. The method of any one of paragraphs 1-6, wherein the thermolysis system has a pressure range from about 10 to about 100 millbar.

8. The method of any one of paragraphs 1-7, further comprising adding hydrogen to the reactor to drive the formation of HF gas following the thermal cleaving of the fluorine from the poly fluoro-aliphatic compounds.

9. The method of any one of paragraphs 1-8, wherein the toxic compounds destroyed and/or removed comprise aromatics and polycyclic aromatic hydrocarbons, halogenated dibenzodioxins, halogenated dibenzofurans, biphenyls, pyrenes, cadmium, lead, antimony, arsenic, beryllium, chlorofluorocarbons, mercury, nickel and other organic compounds present in the waste source, and wherein the Clean Fuel Gas and Char source generated contain less than about 10 ppb of the halogenated organic compounds.

10. The method of any one of paragraphs 1-9, wherein the poly fluoro-aliphatic compounds and optionally additional polymeric materials comprise up to about 10% of the mass of the solar panel and/or cell waste source, or preferably up to about 8% of the mass of the solar panel and/or cell waste source.

11. The method any one of paragraphs 1-10, wherein the poly fluoro-aliphatic compounds comprise PVF and/or PVDF.

12. The method of any one of paragraphs 1-11, wherein the methods do not generate any toxic halogenated organic compounds in the process of converting the waste sources to the Clean Fuel Gas and Char source.

13. The method of any one of paragraphs 1-12, wherein the Char is in the form of a metallic state that is fine, flake and/or chip comprising metal(s), photovoltaic materials and/or silicon, and wherein the method further comprises an additional step of removing one or more of the metals, photovoltaic materials and silicon from the Char.

14. The method of paragraph 13, wherein the metals, photovoltaic materials and silicon are separated from the Char using traditional solid-solid separation equipment and/or techniques.

15. The method of any one of paragraphs 1-14, wherein the Clean Fuel Gas is processed through at least one gas scrubber(s) step wherein the gas fuel is scrubbed, and vapor components undergo fractionated condensation.

16. The method of any one of paragraphs 1-15, wherein the Clean Fuel Gas source further comprise the separation of oil-soluble substances from a gas/vapor mixture following the thermolytic conversion of hydrocarbons in the waste source.

17. The method of any one of paragraphs 1-16, wherein the Char and the fuel gas source are free of halogenated organic compounds, and wherein at least a portion of the fuel gas source generated is provided back to the method for converting waste sources to provide an energy source for such method and/or provided as a fuel source for an alternative application of use.

18. The method of paragraph 17, wherein the fuel gas source provides indirect heat into the thermolysis system.

19. A Clean Fuel Gas produced by the process of any one of paragraphs 1-18.

20. A Char source produced by the process of any one of paragraphs 1-18.

21. The char source of paragraph 20, comprising glass, poly-Si, copper wires, metal from solder, metals from internal attachment posts.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

The disclosure of each reference set forth herein this patent application is incorporated herein by reference in its entirety.

### Example 1

Early studies of thermal degradation of poly(vinylfluoride) (PVF) was studied by Chatfield and reported in The Pyrolysis and Nonflaming Oxidative Degradation of Poly (vinylfluoride), Journal of Polymer Science: Polymer Chemistry Edition, Vol. 21, 1681-1691 (1983). Table 1 shows the summary of low-boiling volatiles from pyrolysis and nonflaming oxidative degradation of PVF at 450° C., where (a) shows Mol % based on all low-boiling volatile degradation products, and (b) shows Mol % excluding CO, CO₂, and H₂O.

TABLE 1

| | | Nonflaming | | | | Nonflaming | |
|---|---|---|---|---|---|---|---|
| | Pyrolysis | Oxidation | | | Pyrolysis | Oxidation | |
| Compound | (mol %) | (a) | (b) | Compound | (mol %) | (a) | (b) |
| CO | — | 32 | — | C₄H₅F | 0.06 | 0.008 | 0.03 |
| CO₂ | — | 0.6 | — | Cyclopentadiene | 0.05 | 0.007 | 0.03 |
| H₂O | — | 43 | — | Benzene | 4.5 | 0.43 | 1.7 |
| HF | 82 | 21 | 83 | Fluorobenzene | 0.3 | 0.03 | 0.1 |
| Methane | 5.2 | 1.7 | 6.8 | Toluene | 1.0 | 0.16 | 0.6 |
| Ethane | 0.6 | 0.06 | 0.2 | C₆H₄(CH₃)F | 0.04 | 0.01 | 0.04 |
| Ethylene | 0.8 | 0.2 | 0.8 | C₆H₅C₂H₅ or | 0.9 | 0.1 | 0.4 |
| | | | | C₆H₄(CH₃)₂ | | | |
| Acetylene | 0.03 | 0.003 | 0.01 | and Styrene | | | |
| Fluoroethylene | 0.07 | 0.06 | 0.2 | n-Propylbenzene | 0.2 | 0.04 | 0.2 |
| Propene | 0.5 | 0.09 | 0.4 | iso-Propylbenzene | 0.3 | 0.02 | 0.08 |
| C₃H₅F | 0.4 | 0.02 | 0.08 | C₆H₅—C₃H₅ | 0.2 | 0.02 | 0.08 |
| Butane | 0.06 | 0.02 | 0.08 | Indene | 0.3 | 0.02 | 0.08 |
| Butene | 1.1 | 0.04 | 0.2 | Napthalene | 0.8 | 0.07 | 0.3 |
| 1,2-Butadiene | 0.2 | 0.03 | 0.1 | Fluoronapthalene | 0.3 | 0.02 | 0.08 |
| 1,3-Butadiene | 0.7 | 0.01 | 0.04 | | | | |

As shown in Table 1 HF is the predominant compound from the thermal degradation of PVF. However various other degradation products are formed, including lower-molecular-weight halogen-containing compounds (e.g. partially-reacted fluorinated compounds) and various other residues. This demonstrates a need for further processing and/or improved processing to ensure that a waste source including PVF is able to completely break down to HF (and no other fluorinated compounds), along with also cracking and removing any tars and oils to provide outputs that only include Clean Fuel Gas and Char that are substantially-free of halogenated organic compounds and do not include tars and/or oils.

### Example 2

Assessment of various solar panels (such as depicted in FIG. 1) was conducted to review and analyze the components of these waste sources that become inputs for processing. Table 2 lists component pieces subjected to processing by the Thermolysis systems showing how the material can be processed:

TABLE 2

| Component | Processing |
|---|---|
| Solar-grade glass | Recycle as glass is not converted into char or |
| | energy. |
| Aluminum frame | Recycle |
| Silicon | Recover, recycle, reuse |
| Metals: e.g. Cu, Ag | Recover, reuse |
| Polymers | Safely convert to energy and safely remove all |
| | halogens |

### Example 3

Systems and apparatus for processing solar panel and/or cell waste sources. Apparatus and processing system has been evaluated to assess the product features and material balances as disclosed pursuant to the embodiments of the invention. Materials of construction have been selected to be halogen tolerant. Testing will be completed to demonstrate the technical capabilities of a plant with a continuous feed of the shredded waste source to yield specific product and operating parameter for further evaluation. The methods according to the invention were evaluated to confirm gas output having a suitable composition with high methane, hydrogen and carbon monoxide content for further usage, and toxic components neutralized in the gas scrubbers with calcium and sodium basic solutions. The methods according to the invention will be evaluated to confirm complete and safe removal of fluorine and other toxic compounds in the Char as non-detectable. The methods according to the invention will be evaluated to assess ability to collect silicon and metal particles from the Char through mechanical separation.

Parameters of the test operation. Feedstock will be received and inspected. After any removal of the metal frames and/or glass panels, the feedstock will be shredded to approximately less than 2 inches. The reactor substantially as depicted in FIG. 3 will be cleaned before the test. Process software and sensors will be adjusted to record the operating conditions. The material handling and infeed conditions will be adjusted before the test. Technical adjustments for this specific feedstock will be implemented as outlined below.

Continuous processing. A continuous plant operation will be conducted after heating the system up with controlled feedstock input and product discharge. The operating parameters will be adjusted to the requirements of the feedstock. The resulting materials and media will be sampled and documented. Gas samples, a feedstock sample and a Char sample will be obtained for further analysis. The analysis of the samples will be carried out by a certified independent laboratory.

Standard operating conditions of the plant included the following preparation of the plant for the operation: Start-up of the plant: 6:30 am; Feedstock Input: from 11:00 am; Sampling between 13:00 and 15:30 pm; Completion of plant operation: until 18:00 pm; Discharge of products and media, Recording of the yielded products for the mass balance.

General conditions. The feedstock will be shredded and was fed according to the test protocol. The start-up process included the heating of the reactors and the adjustments of the gas scrubbing units and adjacent plant components. The operating conditions will be adjusted to the test plant as outlined below.

Plant conditions. The plant operation during the test will use the standard configuration of the system and specific adjustments for this feedstock.

Special conditions of the test operation. The selected basic operating parameters will be continuously monitored and needed only miniscule adjustments. The Infeed volume of the feedstock will be increased during the second phase of the test. The feedstock input will be continuous—in selected intervals.

Summary of apparatus and process set-up. The feedstock reacts quickly in the main reactor at these temperature conditions and gasifies rapidly. This gasification profile will be monitored by the pressure increase shortly after the feedstock is fed into the system. The observed pressure increase is not critical and can be equalized by a more constant feedstock input for a commercial size unit. Beneficially, the gasification and reaction speed of the tested feedstock described herein enables a high throughput volume. The generated gas is piped from the reactor into the gas scrubbing units, which remove the condensates from the gas stream. The condensates are then collected in the scrubbers and their viscosity is suitable for reinjection into the process as a fuel source. Residual tars are not left over in the scrubbers.

Various operational parameters will be adjusted including throughput volumes for the Infeed screw conveyors; adjustments of the steam injections to balance out the reactions in the reactor; reactor temperatures; volume of feedstock input; and residence time dependent on Char removal. With these adjustments and the set-up described a stable plant operation will be achieved.

The plant operation volumes will be measured and recorded to assess input total (kg) and average output (kg/hr).

### Example 4

Benchtop testing for Tedlar processing. A 2.04 g sample of Tedlar was put into a 6″ long 316 stainless steel tube and enclosed by two fine stainless steel wool plugs inside a 4″ tube furnace. The plugs constrained the Tedlar to be in the center of the furnace. This testing that was not completed in the thermolysis system is an example to demonstrate the methods for safely processing and/or recycling solar panel materials and waste sources under similar processing conditions on a small scale. The use of the Thermolyzer system will provide significantly enhanced residence time of the Tedlar and will provide more hydrogen atoms to complete the reactions to HF.

The hydrogen/fluorine ratio was about 3:1. The excess of hydrogen coupled with the high HF bond strength should promote scission of the fluorine bonds in the Teflon and formation of HF which would be precipitated as CaF₂ in the bubblers. The tube was flushed with He to remove all air. The furnace was heated at about a 70° C./min heating rate. After 6 minutes of heating, the temperature reached 400° C. The furnace gradually increased to 495° C. When a temperature of 400° C. was reached, the He flow was reduced to a trickle at that time. The decomposition of Tedlar began around that time and the bubbling increased. The emitted gas was bubbled thru a first bubbler containing just water, then into a second bubbler. This bubbler held 30 ml of water containing 3.30 g of Ca acetate. A second identical Ca acetate solution was simply put into a beaker for later use. These solutions had all been degassed. The furnace was turned off once few bubbles were being emitted. A yellow oil plus a waxy material were observed in the exit Tygon tubing. A cloudiness was observed in the second bubbler indicating that HF had formed in the reaction chamber.

When cool, the tube was weighed. Starting weight was 118.45 g and the weight after heating was 116.64 g for a weight loss of 1.79 g. The yellow oily material weighed 0.46 g. The waxy material was collected and weighed and additional 0.22 g. The stoppers on each end of the tube showed some surface damage. The bubbler with only water was then added to the second Ca acetate solution and a white precipitate occurred. This confirms that the first tube captured emitted HF from the decomposition of Tedlar. The cloudy Ca acetate solutions were decanted, and the solids collected. The steel wool plugs removed easily and were a bluish color on the side facing the center of the tube.

The gas bottles and chain of custody documents were packaged and shipped overnight for analysis by Eurofins. The results for Tedlar processing are shown in Table 3 and clearly demonstrate complete defluorination of the waste source even with the small gas sample evaluated.

TABLE 3

| Species | Composition % |
|---|---|
| H₂ | 20.4 |
| O₂ | 0 |
| N₂ | 0 |
| CH₄ | 24.3 |
| CO₂ | 5.2 |
| CO | 0 |
| Ethane | 12.7 |
| Ethene | 30.9 |
| Propane | 6.1 |
| Propene | 0 |
| i-Butane | 0 |
| n-Butane | 0.4 |
| H₂O | 0.0 |
| Benzene, Aromatics, Olefin | 0.0 |
| TOTAL | 100.0 |

### Example 5

Analysis of the Char source will be conducted to show that the methods of the invention maintain the form of the metals, photovoltaic materials such as silicon, and other elements, without introducing any contaminants and/or other hazardous materials. This beneficially, preserves the value of the metals and other elements. A mass and energy balance of the Char will confirm complete defluorination and removal of other halogens.

### Example 6

Analysis of the Clean Fuel Gas will be conducted to show that the methods of the invention generate gas that is suitable for use as a clean energy source, without introducing any contaminants and/or other hazardous materials. Measurement of at least the following components as shown in Table 4 will be conducted and expected exemplary ranges are shown:

TABLE 4

| Main Components | [Vol-%] |
|---|---|
| H₂ | 12-20 |
| O₂ | 1-2 |
| N₂ | 4-8 |
| CH₄ | 18-25 |
| CO₂ | 15-21 |
| CO | 9-14 |
| Ethane | 1-6 |
| Ethene | 6-14 |
| Propane | 1-5 |
| Propene | 5-9 |
| i-Butane | 0-0.2 |
| n-Butane | 0-0.2 |

1. A method for recycling solar panels and/or cells into a Clean Fuel Gas and Char source comprising:
inputting a solar panel and/or cell waste source comprising at least one poly fluoro-aliphatic compound into a thermolysis system comprising at least one reactor, an oil/water separator, an oil/tar cracker, and at least one gas scrubbers;
undergoing a depolymerization and a cracking reaction of hydrocarbons in the waste source;
thermally cleaving fluorine from the poly fluoro-aliphatic compounds in the waste source;
capturing the fluorine in the scrubbers of the system as HF gas and converting the fluorine to fluoride salts for removal or disposal;
destroying and/or removing toxic compounds present in the waste sources;
generating the Clean Fuel Gas and Char source that are substantially-free of halogenated organic compounds and do not include tars and/or oils; and
wherein the Char source contains recoverable metals, photovoltaic materials and/or silicon.

2. The method of claim 1, further comprising a first step of separating metal frames and/or glass from the solar panel and/or cell waste source.

3. The method of claim 1, further comprising an initial step of shredding the solar panel and/or cell waste source to provide a substantially uniform waste source.

4. The method of claim 3, wherein the solar panel and/or cell waste source has an average diameter of less than about 2 inches before it is inputted into the thermolysis system.

5. The method of claim 1, wherein the at least one reactor has a process temperature of from about 450° C.-800° C. for the waste source to undergo at least partial gasification.

6. The method of claim 1, wherein the thermolysis system provides indirect heat in a system that is free of oxygen.

7. The method of claim 1, wherein the thermolysis system has a pressure range from about 10 to about 100 millbar.

8. The method of claim 1, further comprising adding hydrogen to the reactor to drive the formation of HF gas following the thermal cleaving of the fluorine from the poly fluoro-aliphatic compounds.

9. The method of claim 1, wherein the toxic compounds destroyed and/or removed comprise aromatics and polycyclic aromatic hydrocarbons, halogenated dibenzodioxins, halogenated dibenzofurans, biphenyls, pyrenes, cadmium, lead, antimony, arsenic, beryllium, chlorofluorocarbons, mercury, nickel and other organic compounds present in the waste source, and wherein the Clean Fuel Gas and Char source generated contain less than about 10 ppb of the halogenated organic compounds.

10. The method of claim 9, wherein the poly fluoro-aliphatic compounds and optionally additional polymeric materials comprise up to 10% of the mass of the solar panel and/or cell waste source.

11. The method of claim 10, wherein the poly fluoro-aliphatic compounds comprise PVF and/or PVDF.

12. The method of claim 1, wherein the methods do not generate any toxic halogenated organic compounds in the process of converting the waste sources to the Clean Fuel Gas and Char source.

13. The method of claim 1, wherein the Char is in the form of a metallic state that is fine, flake and/or chip comprising metal(s), photovoltaic materials and/or silicon, and wherein the method further comprises an additional step of removing one or more of the metals, photovoltaic materials and silicon from the Char.

14. The method of claim 13, wherein the metals, photovoltaic materials and silicon are separated from the Char using traditional solid-solid separation equipment and/or techniques.

15. The method of claim 1, wherein the Clean Fuel Gas is processed through at least one gas scrubber(s) step wherein the gas fuel is scrubbed, and vapor components undergo fractionated condensation.

16. The method of claim 1, wherein the Clean Fuel Gas source further comprise the separation of oil-soluble substances from a gas/vapor mixture following the thermolytic conversion of hydrocarbons in the waste source.

17. The method of claim 1, wherein the Char and the fuel gas source are free of halogenated organic compounds, and wherein at least a portion of the fuel gas source generated is provided back to the method for converting waste sources to provide an energy source for such method and/or provided as a fuel source for an alternative application of use.

18. The method of claim 17, wherein the fuel gas source provides indirect heat into the thermolysis system.

19. A Clean Fuel Gas and/or Char source produced by the process of claim 1.

20. (canceled)

21. The Clean Fuel Gas and/or Char source of claim 19, wherein the Char source comprises glass, poly-Si, copper wires, metal from solder, metals from internal attachment posts.
